(19) United States
(12) Patent Application Publication
(10) Pub. No.: US 2007/0080245 A1
(43) Pub. Date: Apr. 12, 2007

(54) Fluid injection devices and analyzing and maintenance methods thereof

(75) Inventors: Chih Ming Lin, Taichung City (TW); Chung Cheng Chou, Taoyuan County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/526,998

(22) Filed: Sep. 25, 2006

(30) Foreign Application Priority Data
Sep. 28, 2005 (TW) TW94133728

(51) Int. Cl. F02M 47/02; B05B 1/30; F02M 43/00; B05B 1/34

(52) U.S. Cl. 239/533.1; 239/88; 239/533.3

(57) ABSTRACT

Fluid injection devices with surface acoustic wave (SAW) devices and methods of analyzing and cleaning the same. The fluid injection device comprises a fluid injection element and a surface acoustic wave device with slanted fingers inter-digital transducers on the fluid injection element. The fluid injection element comprises a fluid chamber in a substrate with a structural layer thereon. At least one fluid actuator is disposed on the structural layer opposing the fluid chamber. A nozzle adjacent to the at least one fluid actuator passes through the structural layer and connects the fluid chamber.

### BACKGROUND OF THE INVENTION

1. Field of the Invention

The invention relates to fluid injection devices, and more particularly, to fluid injection devices with piezoelectric sensors and analysis and maintenance methods of the fluid injection devices.

2. Description of the Related Art

Fluid injection devices have been employed in information technology industries for decades. As micro-system engineering technologies have developed, fluid injection devices have typically been applied in inkjet printers, fuel injection systems, cell sorting systems, drug delivery systems, print lithography systems and micro-jet propulsion systems. Among inkjet printers presently known and used, fluid injection devices can mainly be divided into two categories, continuous mode and drop-on-demand mode, depending on the fluid injection device.

According to the driving mechanism, conventional fluid injection devices can father be divided into thermal bubble driven and piezoelectric diaphragm driven fluid injection devices. Of the two, thermal driven bubble injection has been most successful considering its reliability, simplicity and relatively low cost. No matter which kind of injection device is selected, the velocity, size, and trajectory of the droplet depend on the surface conditions of the injection device. Therefore, the surface conditions of the injection device, including the ink residue, dust, environmental micro-particles and so forth, may have serious influence on the printing quality. Moreover, the dried ink may make the nozzle clogged and then result in the failed nozzle causing bad printing quality; thus, to detect the conditions of the fluid injector device, to maintain the good conditions, and then to provide excellent printing quality is an important problem, which may be solved by adding an ink drying prevention mechanism or a nozzle cleaning mechanism to the fluid injection device.

FIG. 1 is a schematic view of a conventional surface acoustic wave (SAW) sensor having an ink puddle residue. A conventional SAW sensor 4 can be an inter-digital transducer (IDT) comprising a SAW transmitter 41 and a SAW receiver 42 disposed on the surface of a piezoelectric substrate 44. The SAW transmitter 41 comprises a plurality of parallel comb-shaped electrodes 413 and 413′; the comb-shaped electrodes 413 and 413′ are disposed in a staggered manner. An end of each comb-shaped electrodes 413 is connect to a bus bar 412, an end of each comb-shaped electrode 413′ is connected to a bus bar 412′. The bus bar 412 connects a signal generator (not shown) and the bus line 412′ connection is grounded.

Alternately applying bias on the bus bars 412 and 412′ can generate electrical potential between the comb-shaped electrodes 413 and 413′. Since the width of each comb-shaped electrode of a conventional SAW sensor 4 is equal, and the interval between each comb-shaped electrode 413 and 413′ is also equal, the surface acoustic wave 43 on the surface of the piezoelectric substrate 44 can generate SAW signal with a constant resonant frequency.

FIG. 2 is a graphical curve showing the relationship between the insert loss and frequencies received by a SAW receiver. The frequency response signal 51 is shown when the contaminant 45 is not on the propagation path 46. Referring to FIG. 1 again, when the surface acoustic wave 43 on the propagation path 46 encounters a contaminant 45, SAW energy is partially absorbed or reflected by the contaminant 45, thus the frequency response signal 52 is reduced as shown in FIG. 2. More specifically, the attenuation of the SAW energy increases as the absorption ability of contaminant or distribution of the contaminant. That is, the more the SAW energy is attenuated, the less signal the SAW receiver 42 receives. The mass of the contaminant or distribution of the contaminant can thus be decided by the signal difference of insert losses 51 and 52 of FIG. 2.

Conventional SAW sensors 4, however, cannot precisely detect the location of the contaminant 45. For example, the location of the contaminant 45 of the FIG. 3 is different from that of FIG. 1 but the conventional SAW sensors 4 can not distinguish the condition of FIG. 1 from that of FIG. 3. That is to say, the SAW 43 energy attenuations are the same such that the insert loss signals received by the SAW receiver are the same. Contaminants 45 at different sites cannot be differentiated by the SAW sensor 4.

Furthermore, since the attenuation of the SAW energy is dependent on the mass, distribution and absorption ability of the contaminant 45, a contaminant with small area and strong SAW absorption ability may cause the same attenuation as the contaminant with large area but weak SAW absorption ability. Therefore, conventional SAW sensor 4 cannot differentiate contaminants at different locations.

Additionally, conventional inkjet head technologies provide a nozzle plate with selected material or special treatment on the surface of the nozzle plate to eliminate ink residue. Alternatively, a mechanical apparatus may be provided to clean ink residue on the surface of the nozzle plate. For example, a maintenance apparatus can be provided with a cleaning station adjacent to a printing area. When the inkjet head returns, the nozzle surface of the inkjet head is simultaneously cleaned and scraped by the maintenance apparatus. A typical maintenance apparatus can include a cleaning wiper to remove ink residue or clogging on the nozzle surface of the inkjet head.

U.S. Pat. No. 6,629,328, the entirety of which is hereby incorporated by reference, discloses a Wiper to remove residue on the inkjet head. Furthermore, U.S. Pat. No. 6,196,656 discloses a method of cleaning nozzle surface using an ultrasonic generator. When ultrasonic waves are transmitted to the nozzle surface, residue on the nozzle surface is removed by high frequency vibration. Conventional methods of cleaning the nozzle surface require more space consumption and result in a more intricate fluid injection device. Moreover, conventional wiping methods may further damage the nozzle surface.

### BRIEF SUMMARY OF THE INVENTION

Accordingly, the invention is directed to providing a fluid injection device integrating a surface acoustic wave (SAW) device. A SAW device using slanted finger inter-digital transducers (SFIT) is integrated with the fluid injection device, thereby monitoring the conditions of a fluid injection device or maintaining the surface of a fluid injection device.

In one aspect, the invention is directed to providing an analysis method of the fluid injection devices comprising a SFIT SAW transmitter and a SFIT SAW receiver. With surface acoustic wave generated by a SFIT SAW transmitter, the ink puddle residue can be detected.

In another aspect, the invention is directed to providing a maintenance method of the fluid injection devices comprising a SFIT SAW transmitter and a SFIT SAW receiver. With surface acoustic wave generated by a SFIT SAW transmitter, the ink puddle residue can be decomposed and cleaned.

According to an embodiment of the invention, a fluid injection device comprising a fluid injector and a SAW device using slanted finger inter-digital transducers disposed on a structural layer of the fluid injector is provided. The fluid injector comprises a fluid chamber in a substrate to accommodate a fluid with a structural layer thereon, at least one actuator disposed on the structural layer, and a nozzle adjacent to the at least one actuator passing through the structural layer and connecting the fluid chamber.

In one aspect of the invention, the fluid injection device comprises a fluid injector and a SFIT SAW device disposed on a structural layer of the fluid injector.

In another aspect of the invention, a fluid injection device comprises a fluid injector and a SFIT SAW device disposed on a structural layer of the fluid injector. A nozzle of the fluid injector is positioned adjacent to the SFIT SAW transmitter and the SFIT SAW receiver.

According to another embodiment of the invention, an analyzing method of a fluid injection device is provided. The fluid injection device comprises a SFIT SAW transmitter and a SFIT SAW receiver in which a nozzle of the fluid injector is positioned adjacent to the SFIT SAW transmitter and the SFIT SAW receiver. A broadband spectrum is generated by the SFIT SAW transmitter passing through the nozzle plate and received by the SFIT SAW receiver. The spectrum received by the SFIT SAW receiver is compared with another spectrum without surface contamination. If the spectrum received by the SFIT SAW receiver is equal to the spectrum without surface contamination, the printing procedure continuous. If the spectrum received by the SFIT SAW receiver is less than the spectrum with no surface contamination, a maintenance procedure is then proceeds.

According to another embodiment of the invention, a maintenance method of a fluid injection device is provided. A fluid injection device with a SFIT SAW device on a fluid injector is provided. A broadband SAW signal generated by the SAW transmitter using slanted finger inter-digital transducers passes through a contaminated area decomposing by the SAW vibration and finally cleans the surface of fluid injection device by the streaming forces of SAW.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional surface acoustic wave (SAW) sensor on which an ink puddle resides;

FIG. 2 is a graphical curve showing the relationship between the insert loss and the frequencies received by a SAW receiver;

FIG. 3 is a schematic view of a conventional surface acoustic wave (SAW) sensor on which another ink puddle resides at a different location;

FIG. 4 is a schematic view illustrating a SFIT SAW device according to an embodiment of the invention;

FIG. 5 is a spectrum received by the SFIT SAW receiver according to an embodiment of the invention;

FIG. 6 is a schematic view illustrating a SFIT surface acoustic wave (SAW) device on which an ink puddle resides according to an embodiment of the invention;

FIGS. 7A, 8A, 9A, and 10A are schematic views illustrating contaminated areas at different locations or distributions respectively according to several embodiments of the invention;

FIGS. 7B, 8B, 9B, and 10B are spectrums respectively received by the SFIT SAW receiver in associated with the conditions of FIGS. 7A, 8A, 9A, and 10A according to the invention;

FIG. 11A is a schematic view illustrating contaminated areas at different locations or distributions in associated with a SFIT SAW device according to an embodiment of the invention;

FIG. 11B is a spectrum received by the SFIT SAW receiver of FIG. 11A;

FIG. 12 is schematic view of a fluid injection device with a SFIT SAW device according to an embodiment of the invention;

FIG. 13 is a cross section of the fluid injection device of FIG. 12 taken along line A-A;

FIG. 14 is a schematic view of various contaminated areas on the surface of a fluid injection device according to an embodiment of the invention;

FIG. 15 is schematic view of a fluid injection device with a SFIT SAW device according to another embodiment of the invention;

FIG. 16 is a cross section of the fluid injection device of FIG. 16 taken along line B-B;

FIG. 17 is schematic view of a fluid injection device with a SFIT SAW device according to another embodiment of the invention;

FIG. 18 is a cross section of the fluid injection device of FIG. 17 taken along line C-C;

FIG. 19 is schematic view of a fluid injection device 100 with three pairs of SFIT SAW devices according to another embodiment of the invention;

FIG. 20 is a flowchart of a method for analyzing a fluid injection device according to an embodiment of the invention;

FIG. 21 is an illustrations of a fluid injection device with a maintenance SAW device according to another aspect of the invention;

FIG. 22 is a plan view of a fluid injection device with a maintenance SAW device according to an embodiment of the invention;

FIG. 23 is a cross section of the fluid injection device of FIG. 22 taken along line D-D;

FIG. 24 is a cross section showing an ink puddle decomposed by surface acoustic wave according to an embodiment of the invention;

FIG. 25 is a cross section of a fluid injection device 170 with an inter-digital transducer according to another embodiment of the invention;

FIG. 26 is a cross section of a fluid injection device 180 with an inter-digital transducer according to another embodiment of the invention;

FIG. 27 is a plan view of a fluid injection device with a SFIT SAW device providing the functions of analyzing and cleaning according to another aspect of the invention;

FIG. 28 is a cross section of the fluid injection device of FIG. 27 taken along line E-E;

FIG. 29 is a plan view of a fluid injection device with a SFIT SAW device providing the functions of analyzing and cleaning different ink puddles simultaneously according to an embodiment of the invention; and

FIG. 30 is a plan view of a fluid injection device with a SAW device using quasi-slanted finger inter-digital transducers which can provide the functions of analyzing and cleaning according to another embodiment of the invention.

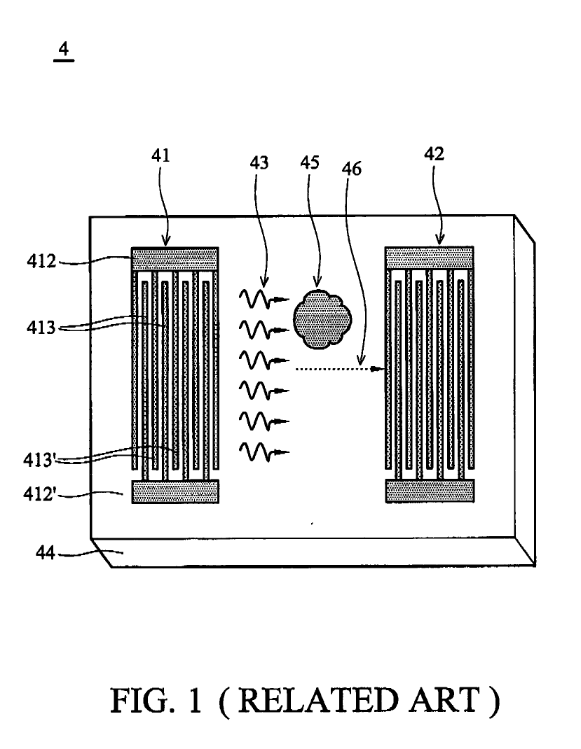

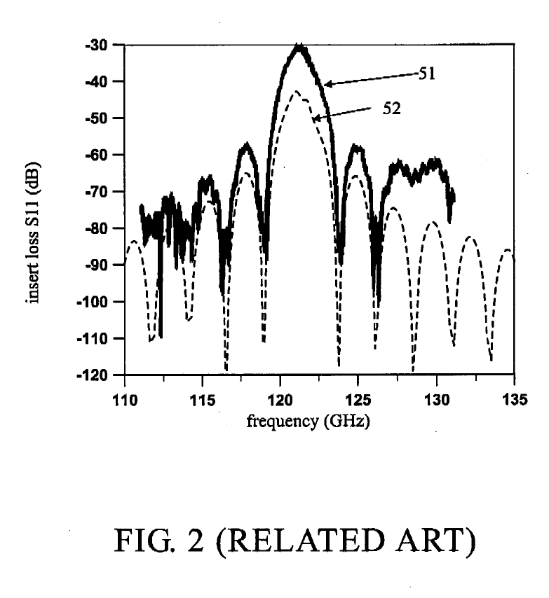

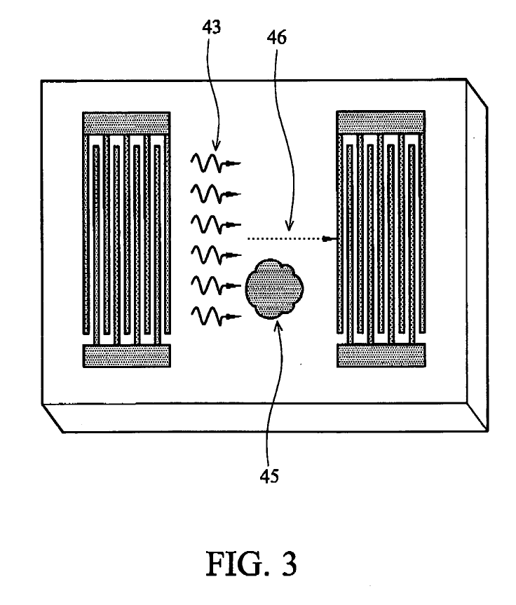

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In a first aspect of the invention, a fluid injection device integrating a surface acoustic wave (SAW) device. A fluid injection element and a SAW device using slanted finger inter-digital transducers on the fluid injection element are provided. The fluid injection element comprises a fluid chamber on a substrate to accommodate fluid. A structural layer is disposed on the substrate. At least one fluid actuator is disposed on the structural layer opposing the fluid chamber. A nozzle is disposed adjacent to the fluid actuator and connecting the fluid chamber.

The following description is of the best-contemplated mode of carrying out the invention. This description is made for the purpose of illustrating the general principles of the invention and should not be taken in a limiting sense. The scope of the invention is best determined by reference to the appended claims.

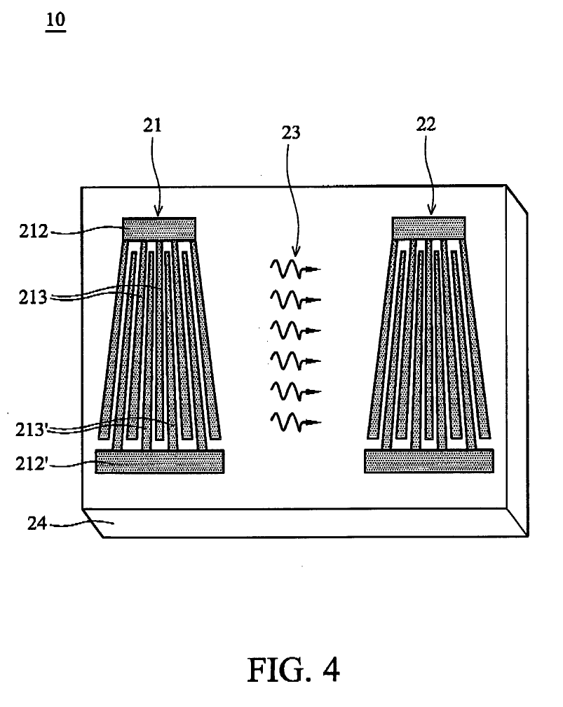

FIG. 4 is a schematic view illustrating a SFIT surface acoustic wave (SAW) device according to an embodiment of the invention. In FIG. 4, a SAW device 10 includes a SFIT SAW transmitter 21 and a SFIT SAW receiver 22 disposed on a layer 24 of piezoelectric materials. A SAW signal 23 is generated by the SFIT SAW transmitter 21 passing through a surface of the layer 24 and received by the SFIT SAW receiver 22.

The SFIT SAW transmitter 21 comprises a plurality of electrodes 213 and 213′ with various line widths. The electrodes 213 and 213′ are staggered and interposed with each other. One end of the electrodes 213 connects to a first bus line 212, and one end of the electrodes 213′ connects to a second bus line 212′. The longitudinal axis of electrode 213 and 213′ are not perpendicular to the first and the second bus lines 212 and 212′. According to the invention, the first bus line 212 is preferably connected to a source (not shown), and the second bus line is preferred grounded. The source (not shown) can be an alternate current source providing potential between the first and the second bus lines 212 and 212′. When the source is switched on, a specific bandwidth SAW signal 23 on the surface of the layer 24 is generated by the SFIT SAW transmitter 21, received by the SFIT SAW receiver 22 and then converted into electric signal by an external circuit.

According to the invention, the surface acoustic wave 23 is preferably at a central frequency of 60 MHz and with a surface acoustic velocity of 3488 m/s. The slanted finger electrodes 213 are tapered from one end of 12.4 μm to the other end of 16.6 μm. The SFIT SAW transmitter 21 has approximately 30 pairs of electrodes, and the SFIT SAW receiver 22 has approximately 20 pairs of electrodes. Since the distance between the lowest nozzle of the lower row injectors and the highest nozzle of the upper row injectors on the fluid injection device is about 5000 μm, the aperture of the SFIT SAW transmitter 21 and the SFIT SAW receiver are preferably about 5000 μm.

Note that the transmission route 46 of the surface acoustic wave 23 can pass through such as peripheral regions of the nozzle of the injection device. When passing through the peripheral regions of the nozzle, the energy of surface acoustic wave 23 is affected by surface conditions of the peripheral regions, thereby determining surface conditions such as the ink residues, crystallization clogging, or contaminants.

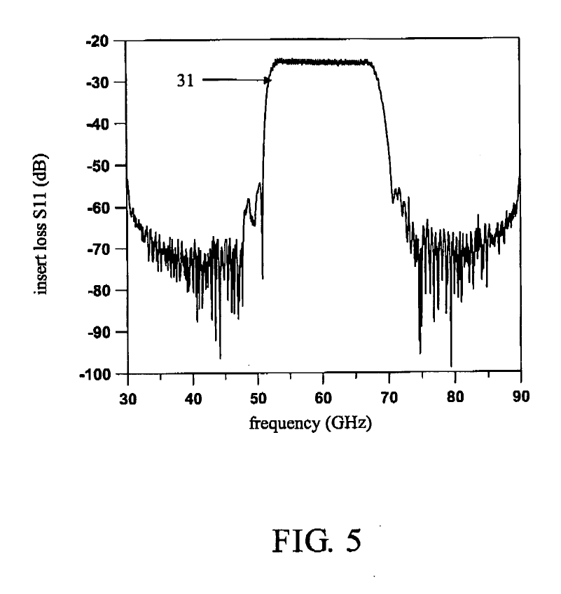

FIG. 5 is a spectrum received by the SFIT SAW receiver 22 according to an embodiment of the invention. Referring to FIG. 5, a spectrum 31 received by the SFIT SAW receiver 22 comprises a central frequency of 60 MHz and a frequency range from 51 MHz to 59 MHz. The energy loss of the SAW signal can be measured by an insertion loss dependent upon the response frequency, thereby determining location and dimensions of an ink residue or the dust on the surface. More specifically, the surface conditions of the peripheral regions of the nozzle can be simultaneously determined by the energy loss of the SAW signal. If the surface is contaminated, a maintenance procedure proceeds to prevent the bad printing quality.

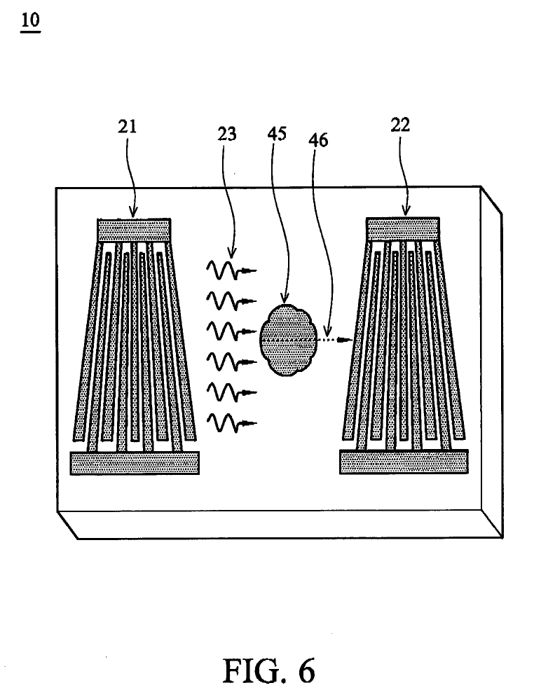

FIG. 6 is a schematic view illustrating a SFIT SAW device 10 according to an embodiment of the invention. In FIG. 6, a contaminated area 45 is positioned at the propagation path 46 between a SFIT SAW transmitter 21 and a SFIT SAW receiver 22. A SAW signal 23 is generated by the SFIT SAW transmitter 21 passing through the contaminated area 45 and then received by the SFIT SAW receiver 22.

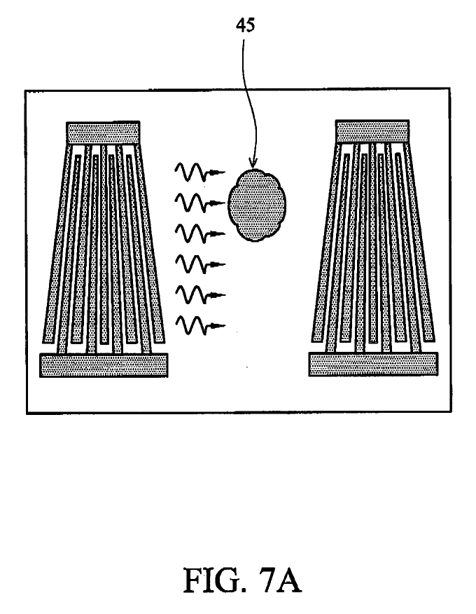

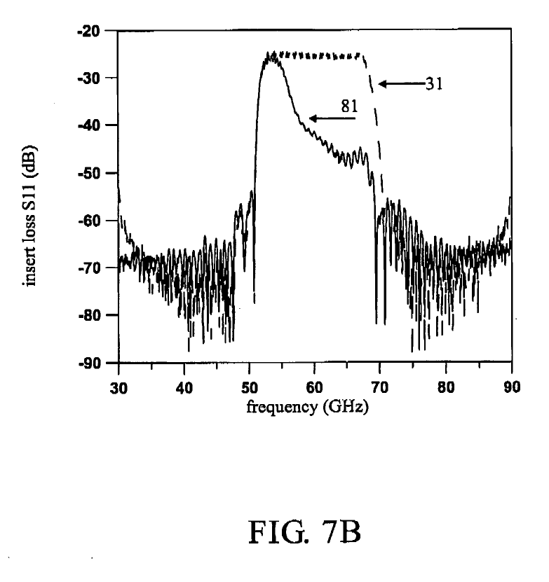

FIGS. 7A, 8A, 9A, and 10A each illustrates a contaminated area 45 with different locations or distributions according to several embodiments of the invention. FIGS. 7B, 8B, 9B, and 10B each illustrates a spectrum received by the SFIT SAW receiver 22 in associated with the conditions of FIGS. 7A, 8A, 9A, and 10A according to the invention. Each curve 81, 91, 101, and 111 is a response frequency signal corresponding to the conditions of FIGS. 7A, 8A, 9A, and 10A respectively. Compared to the spectrum 31 in FIG. 5, the location or distribution of the contaminated area 45 can be determined.

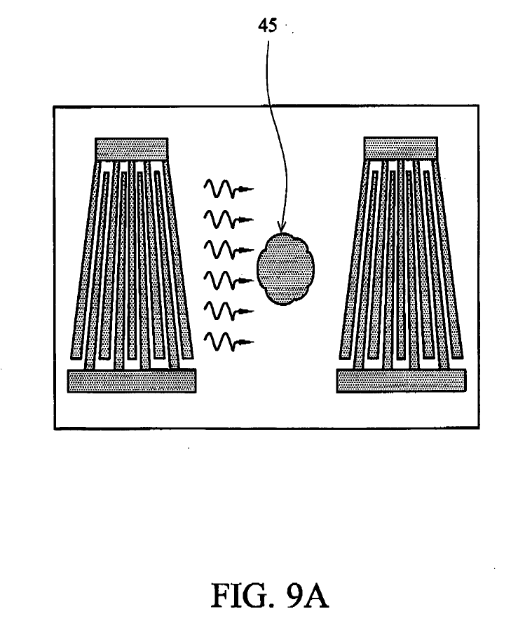

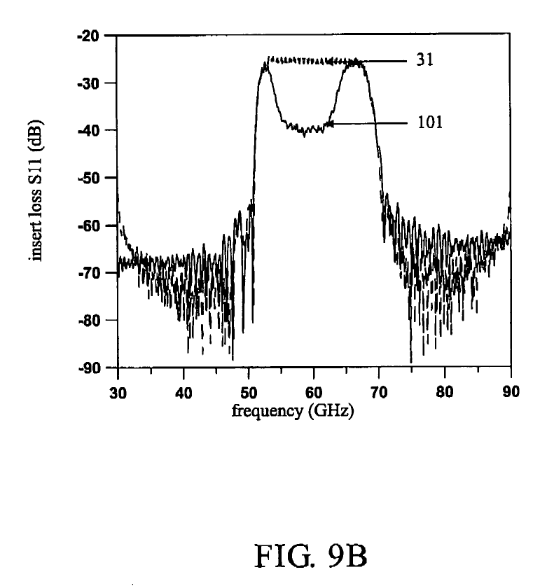

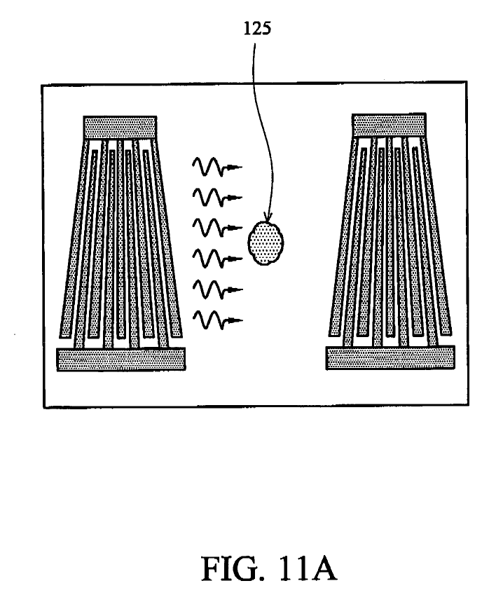

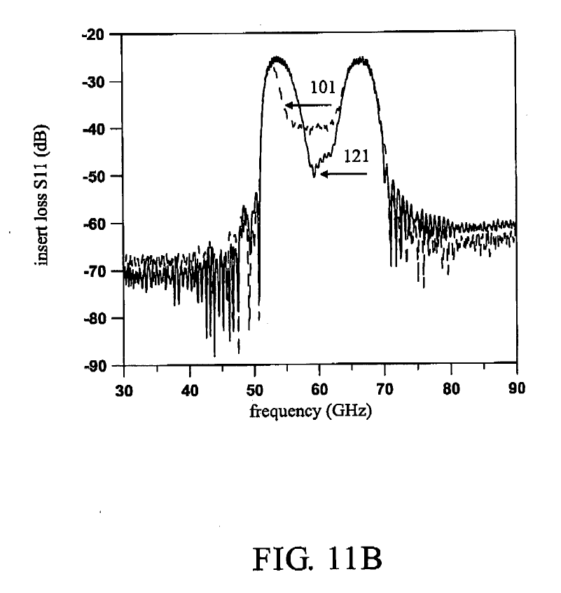

Since different surface contaminated materials with different ability of SAW energy absorption lead to different energy loss of SAW signal, the contaminated material 125 with strong ability of SAW energy absorption in FIG. 11A causes more energy loss than contaminated material 45 with weak ability of SAW energy absorption in FIG. 9A. Although the locations of contaminated areas 45 and 125 are almost identical, the levels of energy loss of the SAW signal at the same frequency are different. For example, referring to FIG. 11B, the level of energy loss of the SAW signal 121 caused by contaminated area 125 at 60 MHz is greater than the level of energy loss of the SAW signal 101 caused by contaminated area 45 at 60 MHz, thereby determining the contaminated materials with different ability of SAW energy absorption at same location by the different levels of energy loss of the SAW signal.

According to one embodiment of the invention, the SFIT SAW device comprises a layer of piezoelectric materials on a structural layer and a pair of slanted finger inter-digital electrodes on the piezoelectric layer. In addition, a passivation layer is formed on the pair of slanted finger inter-digital electrodes and a cover layer is overlaid on the structural layer.

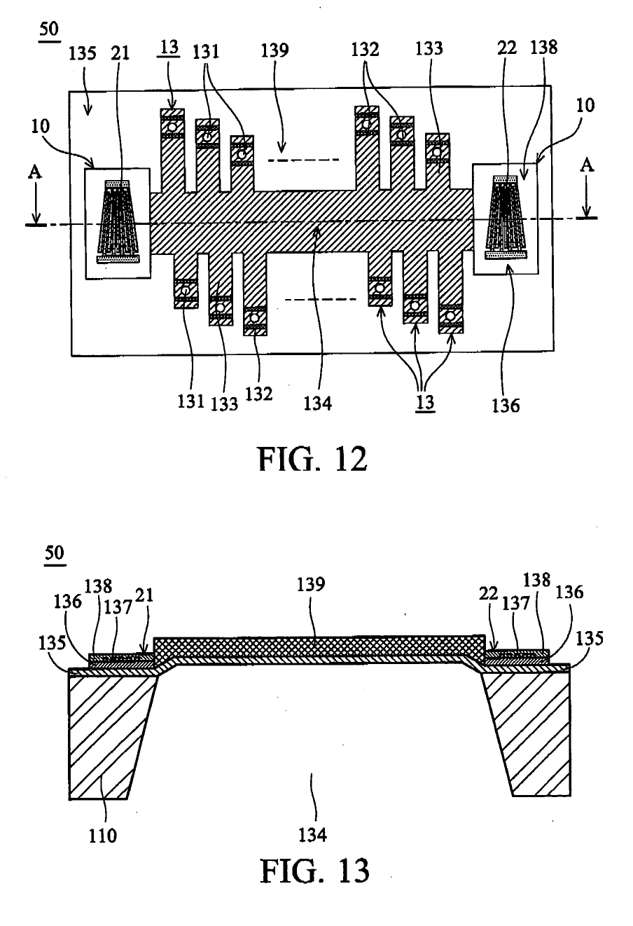

FIG. 12 is schematic view of a fluid injection device with a SFIT SAW device according to an embodiment of the invention. FIG. 13 is a cross section of the fluid injection device of FIG. 12 taken along line A-A. Referring to FIG. 13, a fluid injection device 50 with a SFIT SAW device 10 includes a substrate 110. A structural layer 135 is formed on the substrate 110. A piezoelectric layer 136 is formed on the structural layer 135. The SAW device 10 comprising a SFIT SAW transmitter 21 and a SFIT SAW receiver 22 is formed on the piezoelectric layer 136. Both the SFIT SAW transmitter 21 and the SFIT SAW receiver 22 are formed by slanted finger inter-digital electrodes 137. A passivation layer 138 is formed on the slanted finger inter-digital electrodes 137. A cover layer 139 is formed on the structural layer 135.

The fluid injection device 50 with a SFIT SAW device 10 further comprises a plurality of injectors 13 connecting a manifold 134. Each injector 13 comprises a fluid chamber 133 and a nozzle 131 and a heater 132.

According to the invention, the substrate 110 comprises a single crystal silicon wafer. The structural layer 135 is preferably formed by low stress silicon nitride (Si₃N₄). The piezoelectric layer 136 is preferably formed by aluminum nitride (AlN), zinc oxide (ZnO), lithium niobium oxide LiNbO₃), lithium tantalum oxide (LiTaO₃), lead zirconium titanium oxide (PZT), and so on.

The slanted finger inter-digital electrodes 137 comprise a metal layer such as aluminum (Al) or gold (Au). The passivation layer 138 can be silicon nitride (Si₃N₄) or silicon dioxide (SiO₂). The cover layer 139 can be a metal layer such as Au, Ni, Cu, and so forth, or an insulator layer formed by a dry film.

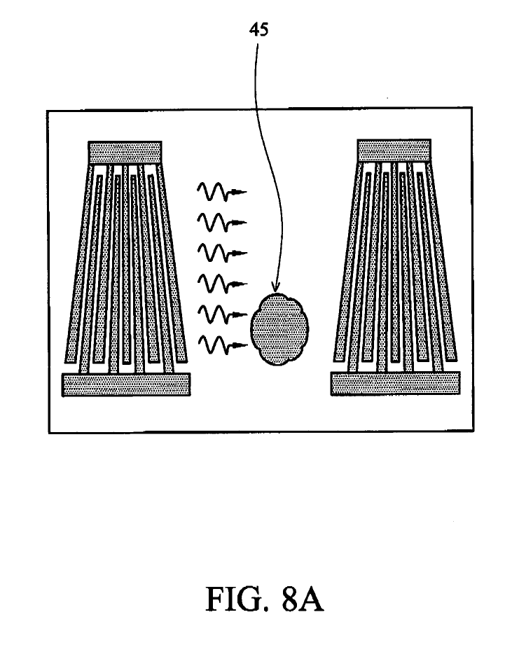

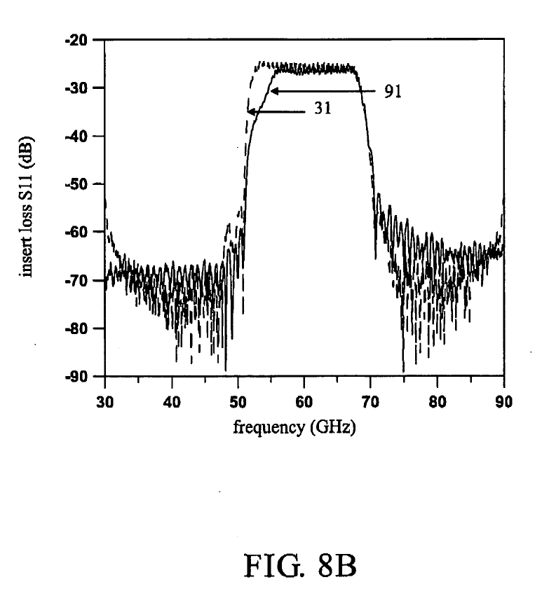

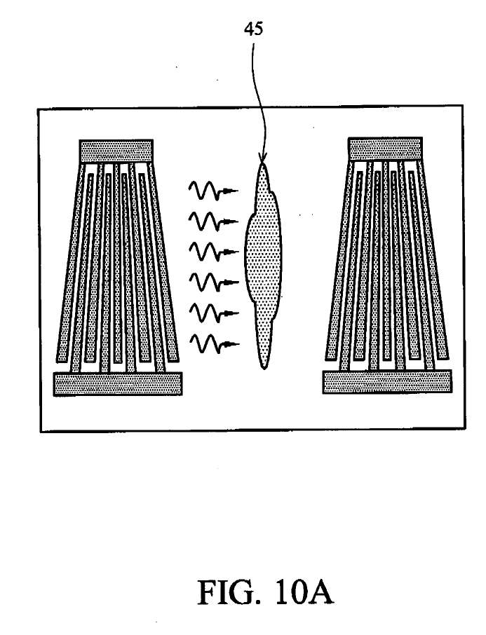

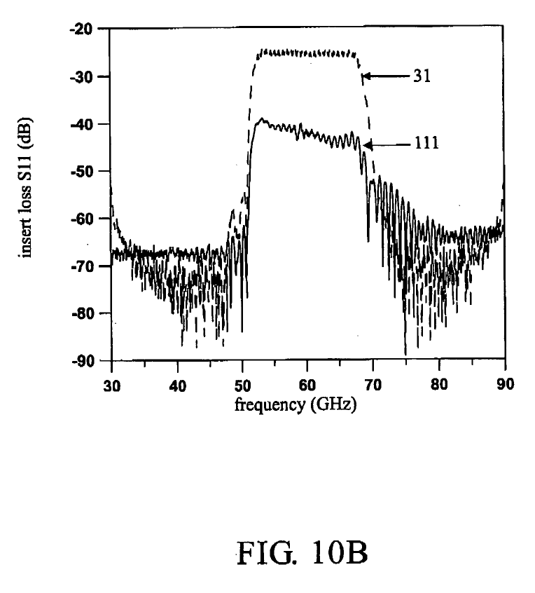

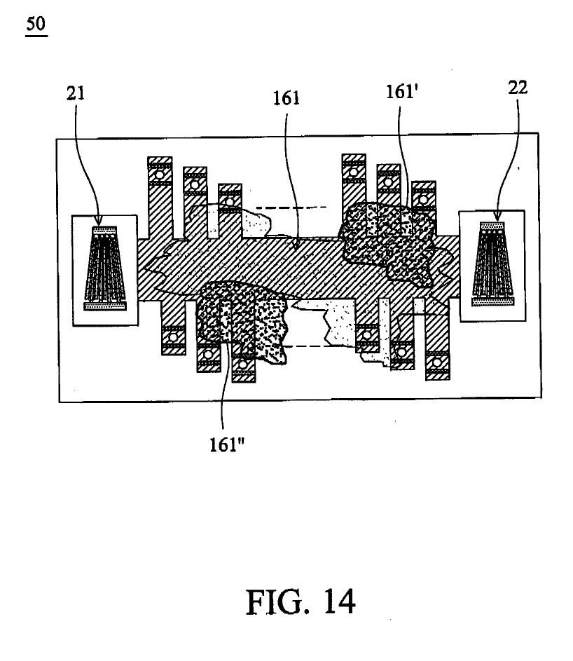

FIG. 14 is a schematic view of various contaminated areas on the surface of a fluid injection device according to an embodiment of the invention. Referring to FIG. 14, when an ink puddle 161 resides on the surface of a fluid injection device 50, a SAW signal is generated by the SFIT SAW transmitter 21 passing through the ink puddle 161 and then received by the SFIT SAW receiver 22. If a spectrum of insertion loss of the SAW signal is identical to curve 111 of FIG. 10B, the existence of an ink puddle 161 at the whole surface of fluid injection device is determined and a maintenance procedure is required. On the other hand, when a spectrum of insertion loss of the SAW signal is identical to curve 81 of FIG. 7B, existence of an ink puddle 161′ is determined at nozzles of upper row injectors. Furthermore, when a spectrum of insertion loss of the SAW signal is identical to curve 91 of FIG. 8B, the existence of an ink puddle 161″ is determined at nozzles of lower row injectors.

According to an exemplary embodiment of the invention, when a spectrum of insertion loss of the SAW is identical to curve 111 of FIG. 10B, curve 81 if FIG. 7B, or curve 91 of FIG. 8B, the existence of an ink puddle can be determined at which location of injectors, and then a maintenance procedure is performed to partially or entirely clear the fluid injection device. Alternatively, when a spectrum of insertion loss of the SAW is identical to curves 101 or 121 of FIG. 11B, the existence of either a liquid ink puddle or a crystallized ink residue can be determined at nozzles of the injectors. For example, if existence of a liquid ink puddle is determined, a regular maintenance procedure is performed to partially or entirely clear the fluid injection device; on the other hand, if existence of a crystallized ink residue is determined, a mechanical wiping or multiple maintenance procedures are performed to clear the fluid injection device.

Alternatively, according to another embodiment of the invention, the SFIT SAW device comprises a pair of slanted finger inter-digital electrodes on a structural layer and a layer of piezoelectric materials on the slanted finger inter-digital electrodes In addition, a passivation layer is formed on the piezoelectric layer and a cover layer is overlaid on the structural layer.

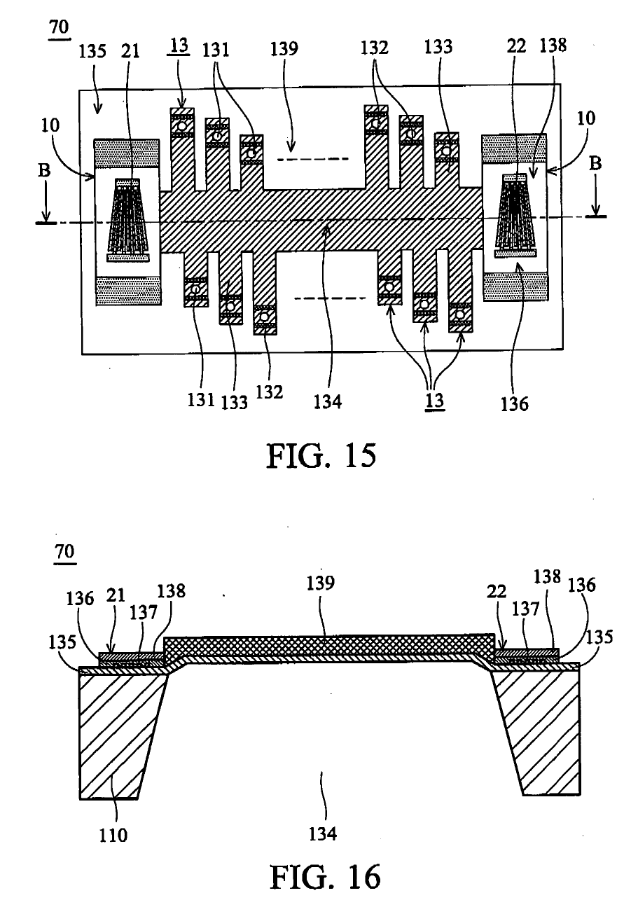

FIG. 15 is schematic view of a fluid injection device with a SAW device according to another embodiment of the invention. FIG. 16 is a cross section of the fluid injection device of FIG. 15 taken along line B-B. Referring to FIG. 16, a fluid injection device 70 comprises a substrate 110 and a structural layer 135 on the substrate 110. The SAW device 10 comprising a SFIT SAW transmitter 21 and a SFIT SAW receiver 22 is formed on the structural layer 135. Both the SFIT SAW transmitter 21 and the SFIT SAW receiver 22 are formed by slanted finger inter-digital electrodes 137. A piezoelectric layer 136 is formed on the SFIT SAW transmitter 21 and the SFIT SAW receiver 22, and a passivation layer 138 is formed on the piezoelectric layer 136. A cover layer 139 is overlaid on the structural layer 135.

Alternatively, according to another embodiment of the invention, the SFIT SAW device comprises a pair of slanted finger inter-digital electrodes on the structural layer and a piezoelectric layer on the pair of slanted finger inter-digital electrodes. In addition, a cover layer is overlaid on the structural layer.

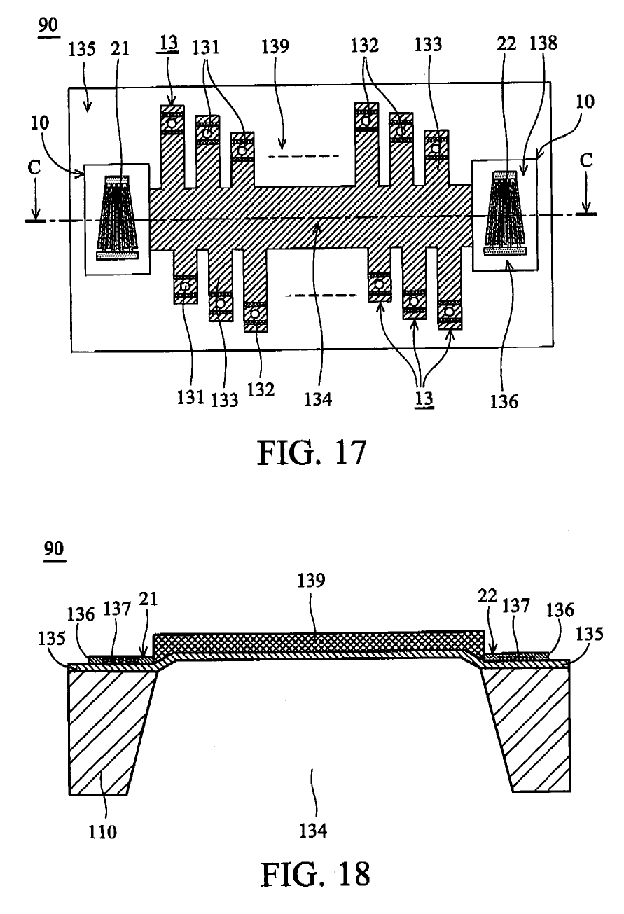

FIG. 17 is schematic view of a fluid injection device with a SAW device according to another embodiment of the invention. FIG. 18 is a cross section of the fluid injection device of FIG. 17 taken along line C-C. Referring to FIG. 18, a fluid injection device 90 comprises a substrate 110 and a structural layer 135 on the substrate 110. The SAW device 10 comprising a SFIT SAW transmitter 21 and a SFIT SAW receiver 22 is formed on the structural layer 135. Both the SFIT SAW transmitter 21 and the SFIT SAW receiver 22 are formed by slanted finger inter-digital electrodes 137. A piezoelectric layer 136 is formed on the slanted finger inter-digital electrodes 137. A cover layer 139 is overlaid on the structural layer 135.

The fluid injection device 90 further comprises a plurality of injectors 13 connecting a manifold 134. Each injector 13 comprises a fluid chamber 133 and a nozzle 131 and a heater 132.

Accordingly, the fluid injection device 90 provides a method for analyzing and maintaining the surface of the fluid injection device 90 as well as the fluid injection devices 50 and 70. Note that the fluid injection device 90 differs from the fluid injection devices 50 and 70 in that the piezoelectric layer 136 is formed on the slanted finger inter-digital electrodes 137, thereby not only providing protection of the slanted finger inter-digital electrodes 137 but also simplifying fabrication steps of the fluid injection device 90.

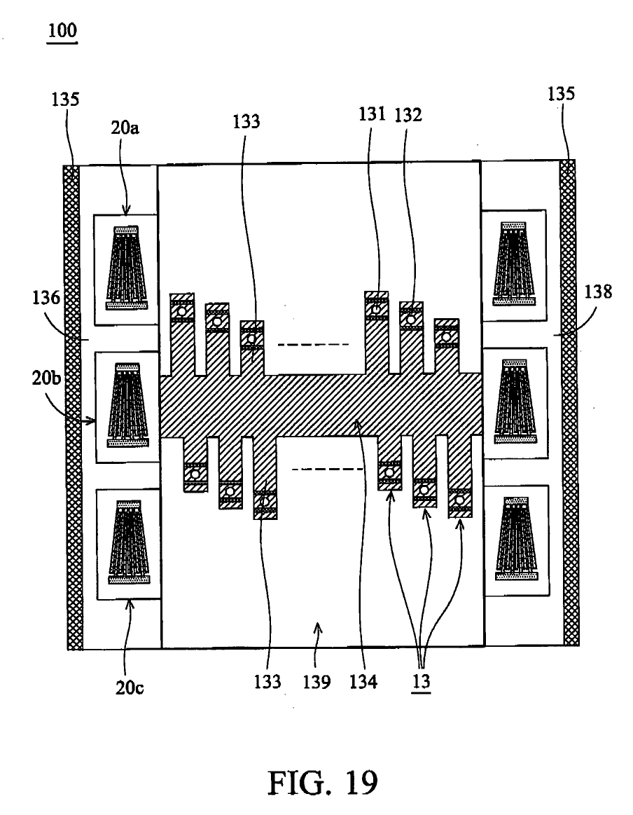

FIG. 19 is schematic view of a fluid injection device 100 with SFIT SAW devices according to another embodiment of the invention. The fluid injection device 100 comprises a substrate 110 and a structural layer 135 thereon. A piezoelectric layer 136 is formed on the structural layer 135. Three pairs of SFIT SAW devices 20a, 20b, and 20c are disposed on the piezoelectric layer 136. A passivation layer is disposed on the three pairs of SFIT SAW devices 20a, 20b, and 20c. A cover layer 139 is overlaid on the structural layer 135.

The fluid injection device 100 further comprises a plurality of injectors 13 connecting a manifold 134. Each injector 13 comprises a fluid chamber 133 and a nozzle 131 and a heater 132. A first pair of SFIT SAW devices 20a is positioned at an upper row of the injectors. A second pair of SFIT SAW devices 20b is positioned at an area between the upper row and the lower row of the injector. A third pair of SFIT SAW devices 20c is positioned at a lower row of the injectors.

In FIG. 19, the fluid injection device 100 comprising three pairs of SFIT SAW devices 20a, 20b, and 20c can analyze wider region of the surface conditions.

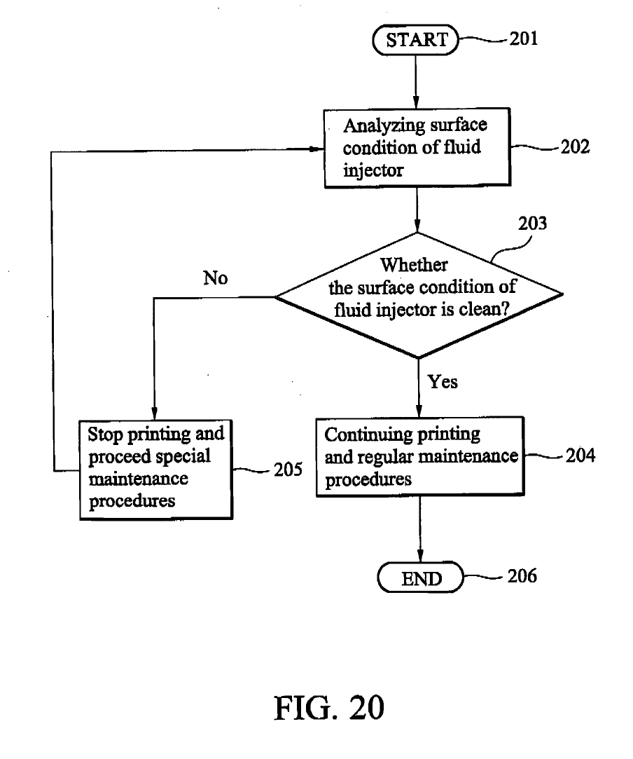

FIG. 20 is a flowchart of a method for analyzing a fluid injection device according to an embodiment of the invention. A fluid injection device comprises a SFIT SAW transmitter and a SFIT SAW receiver, wherein a nozzle of the fluid injection device is positioned adjacent to the SFIT SAW transmitter and the SFIT SAW receiver. The SFIT SAW transmitter generates a SAW spectrum (step 201) passing through and analyzing the surface of the nozzle (Step 202); then the SAW spectrum would be received by the SFIT SAW receiver. Next, the SAW spectrum received by the SFIT SAW receiver is compared with a SAW spectrum when there is no contamination on the surface (step 203). If the SAW spectrum is identical to the SAW spectrum without surface contamination, the printing process continues (step 204). Alternatively, if the SAW spectrum is different from the SAW spectrum without surface contamination, the existence of an ink puddle or a contaminated area which would reduce the SAW energy is detected on the surface of the injector and then a maintenance procedure is required (step 205).

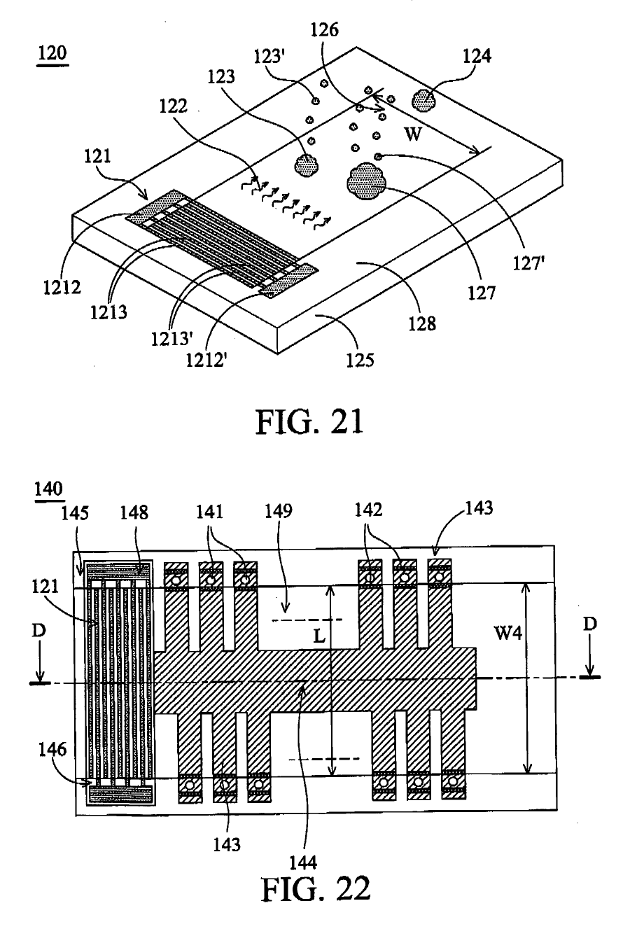

In another aspect of the invention, a fluid injection device and a maintenance method are provided. FIG. 21 is a schematic view of a fluid injection device with a SAW maintenance device according to another aspect of the invention. In FIG. 21, a fluid injection device 120 comprises an inter-digital transducer 121 on a piezoelectric layer 125. The inter-digital transducer 121 comprises a plurality of parallel staggered electrodes 1213 and 1213′. Both electrodes 1213 and 1213′ are disposed in a staggered manner, wherein one end of each electrode 1213 is connected to a first bus line 1212, and one end of each electrode 1213′ is connected to a second bus line 1212′. The longitudinal axis of electrodes 1213 and 1213′ are perpendicular to the first and the second bus lines 1212 and 1212′. According to the invention, the first bus line 1212 is preferably connected to a source (not shown), and the second bus line 1212′ is preferably grounded. The source (not shown) can be an alternating current (AC) source providing potential between the parallel staggered electrodes 1213 and 1213′. When the AC source switches on, a specific bandwidth SAW signal 122 is generated on the surface 128 of the piezoelectric layer 125 by the inter-digital transducer 121.

Referring to FIG. 21, if a driving voltage on the AC source is sufficient to trigger the SAW 122 with large amplitude, an ink puddle 123 can be driven along the SAW propagation direction 126 on the surface 128 of the piezoelectric layer 125. Moreover, the ink puddle 123 can be further decomposed into smaller drops 123′ leaving the piezoelectric surface. As a result, not only is the position of the ink puddle 123 changed, but the ink puddle 123 becomes a smaller ink puddle 124. If a large ink puddle 127 resides on the surface 128 of the piezoelectric layer 125, an AC voltage is continuously applied on the inter-digital transducer 121 until the large ink puddle 127 is completely cleaned by the SAW 122.

Accordingly, an ink puddle 123 can be driven along the SAW propagation direction 126 on the piezoelectric layer 128. The ink puddle 123 can be completely removed by the SAW 122 due to continuously vibration on the surface 128.

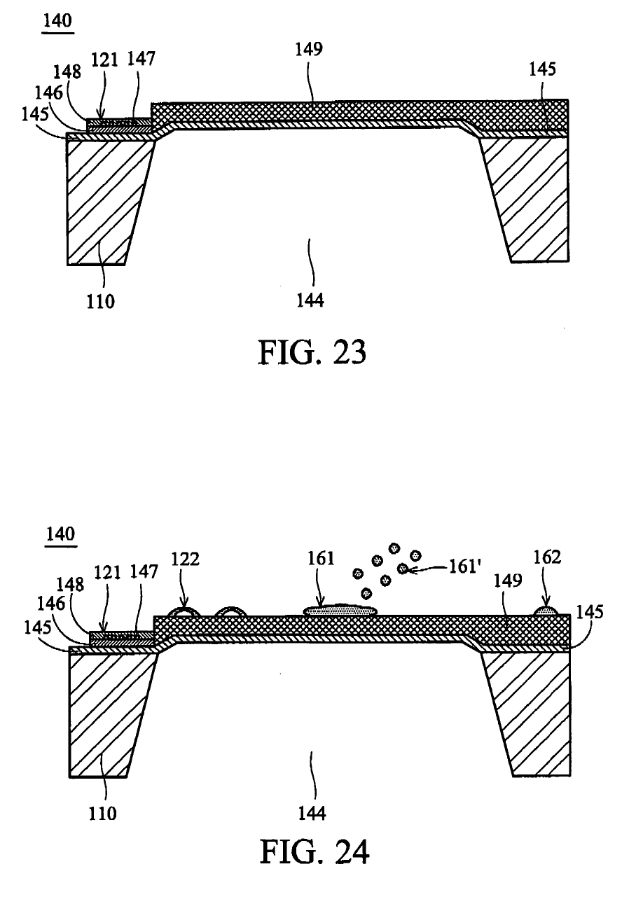

FIG. 22 is a plan view of a fluid injection device with a SAW maintenance device according to an embodiment of the invention. FIG. 23 is a cross section of the fluid injection device of FIG. 22 taken along line D-D. Referring to FIG. 23, a fluid injection device 140 includes a substrate 110 and a structural layer 145 on the substrate 110. A piezoelectric layer 146 is formed on the structural layer 145. An inter-digital transducer 121 comprising a plurality of parallel staggered electrodes 147 is formed on the piezoelectric layer 146. The length of the inter-digital transducer 121 is W4 which is approximately equal to the distance L between two adjacent to nozzles of the fluid injector, thereby preventing crosstalk. A passivation layer 148 is formed on the staggered electrodes 147. A cover layer 149 is overlaid on the structural layer 145.

The fluid injection device 140 further comprises a plurality of injectors connecting a manifold 144. Each injector comprises a fluid chamber 143 and a nozzle 141 and a beater 142.

According to the invention, the substrate 110 comprises a single crystal silicon wafer. The structural layer 145 is preferably formed by low stress silicon nitride (Si₃N₄). The piezoelectric layer 146 is preferably formed by aluminum nitride (AlN), zinc oxide (ZnO), lithium niobium oxide (LiNbO₃), lithium tantalum oxide (LiTaO₃), lead zirconium titanium oxide (PZT), and so forth.

The staggered electrodes 147 of the inter-digital transducer 121 comprise a metal layer such as aluminum (Al) or gold (Au). The passivation layer 148 can be silicon nitride (Si₃N₄) or silicon dioxide (SiO₂). The cover layer 149 can be a metal layer such as Au, Ni, Cu, and so forth, or an insulator layer formed by a dry film.

Referring to FIG. 24, an ink puddle 161 on a surface of the fluid injection device 140 can be removed by the surface acoustic wave 122 generated by the inter-digital transducer 121. Since the SAW 122 exerts a streaming force on the ink puddle 161, the ink puddle 161 can be decomposed into smaller ink particles 161′. As such, not only is the position of the ink puddle 161 changed, but the ink puddle 161 becomes a smaller ink puddle 162. An AC voltage is continuously applied on the inter-digital transducer 121 until the smaller ink puddle 162 is completely decomposed by the SAW 122.

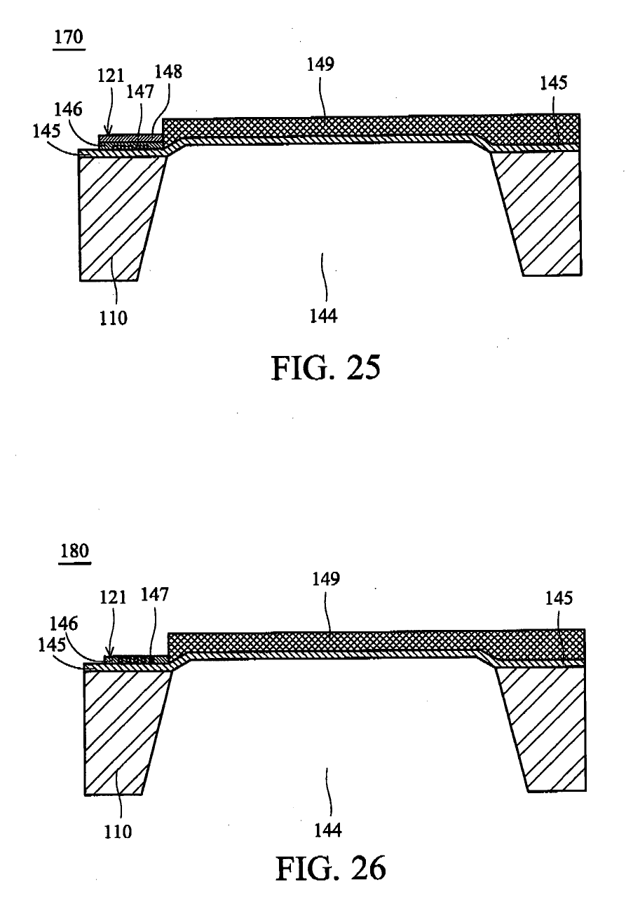

FIG. 25 is a cross section of a fluid injection device 170 with an inter-digital transducer according to another embodiment of the invention. Compared to the fluid injection device 140, the inter-digital transducer 121 of the fluid injection device 170 is directly disposed on the structural layer 145. A piezoelectric layer 146 is disposed on the inter-digital transducer 121 and a passivation layer 148 is formed on the piezoelectric layer 146.

FIG. 26 is a cross section of a fluid injection device 180 with an inter-digital transducer according to another embodiment of the invention. Compared to the fluid injection devices 140 and 170, the inter-digital transducer 121 of the fluid injection device 180 is directly disposed on the structural layer 145. A piezoelectric layer 146 is disposed on the inter-digital transducer 121, thereby not only providing protection on the inter-digital transducer 121 but also simplifying fabrication steps of the fluid injection device 180.

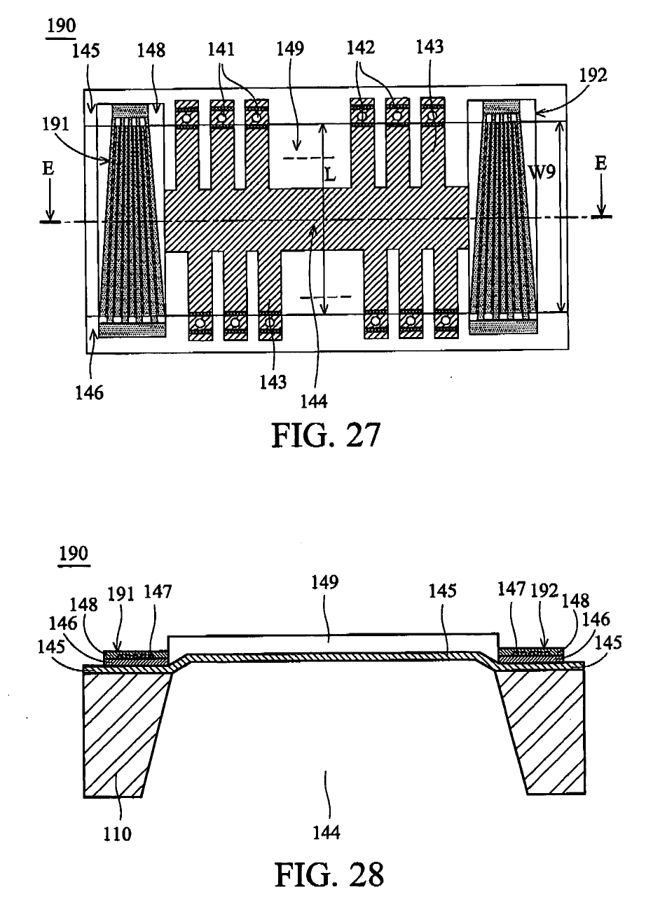

Alternatively, in another aspect of the invention, a fluid injection device and a maintenance method are provided. FIG. 27 is a plan view of a fluid injection device with a SFIT SAW device providing the functions of analyzing and cleaning according to another aspect of the invention. FIG. 28 is a cross section of the fluid injection device of FIG. 27 taken along line E-E. Referring to FIG. 28, a fluid injection device 190 includes a substrate 110 and a structural layer 145 on the substrate 110. A piezoelectric layer 146 is formed on the structural layer 145. A slanted finger inter-digital transmitter 191 comprising a plurality of slanted finger staggered electrodes 147 is formed on the piezoelectric layer 146. On the other side, a slanted finger inter-digital receiver 192 comprising a plurality of slanted finger staggered electrodes 147 is formed on the piezoelectric layer 146. The length of the slanted finger inter-digital transducer 191 and 192 is W9 which is approximately equal to the distance L between two adjacent to nozzles of the fluid injector, thereby preventing crosstalk. A passivation layer 148 is formed on the slanted finger inter-digital transducer 191. A cover layer 149 is overlaid on the structural layer 145.

The fluid injection device 190 further comprises a plurality of injectors connecting a manifold 144. Each injector comprises a fluid chamber 143 and a nozzle 141 and a heater 142.

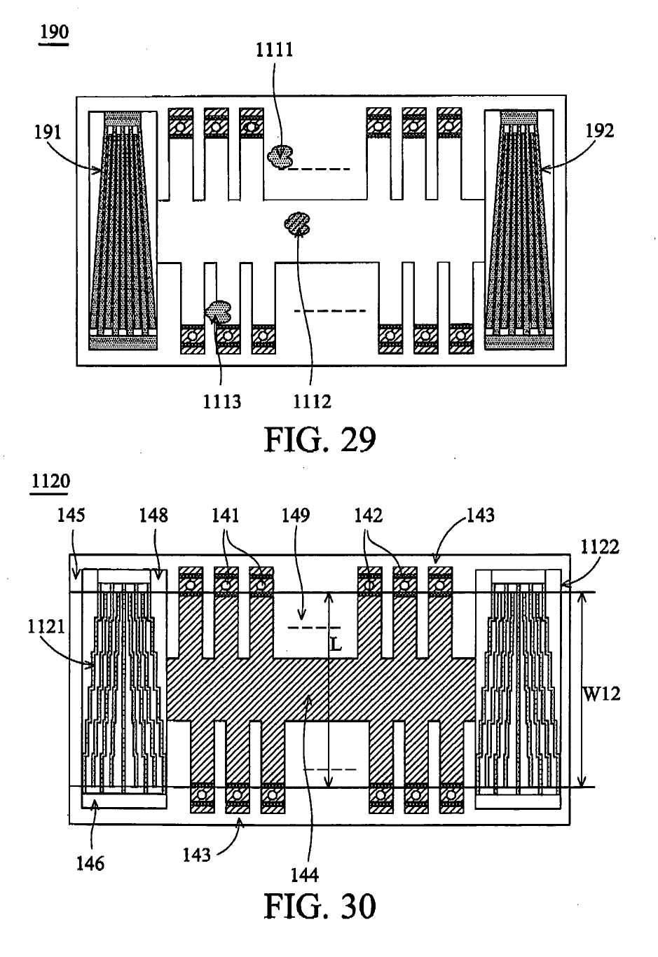

Compared to the fluid injection device 140 of FIG. 22, the fluid injection device 190 can provide both analysis and maintenance of the injector surface as shown in FIG. 29. When ink puddles 1111, 1112, and 1113 reside at different locations on the injector surface, the ink puddles 1111, 1112, and 1113 are separately detected by a broadband SAW generated by the SFIT SAW transmitter 191. In sequence, the alternating current (AC) source can trigger stronger SAW signals with different frequencies separately to remove each ink puddle according to the location and volume of the ink puddle.

Referring to FIG. 29, the slanted finger inter-digital transmitter 191 can generate a broadband SAW signal with a central frequency at 60 MHz and a bandwidth at a range of 51 MHz-69 MHz. The narrow end of the slanted finger inter-digital transducer 191 can generate a high frequency SAW signal of 69 MHz, while the wide end of the slanted finger inter-digital transducer 191 can generate a low frequency SAW signal of 51 MHz. If the existence of an ink puddle 1111 is detected, a 69 MHz AC bias is applied to the slanted finger inter-digital transducer 191 to generate a 69 MHz SAW to remove the ink puddle 1111. Alternatively, if the existence of an ink puddle 1112 is detected, a 60 MHz AC bias is applied to the slanted finger inter-digital transducer 191 to generate a 60 MHz SAW to remove the ink puddle 1112. Moreover, if the existence of an ink puddle 1113 is detected, a 51 MHz AC bias is applied the slanted finger inter-digital transducer 191 to generate a 51 MHz SAW to remove the ink puddle 1113. Accordingly, the fluid injection device 190 can generate SAW signals with different frequencies according to the locations and volumes of ink puddles.

FIG. 30 is a plan view of a fluid injection device with a SAW device using quasi-slanted inter-digital transducers which can provide the functions of analysis and cleaning according to another embodiment of the invention. Referring to FIG. 30, a fluid injection device 1120 includes a quasi-slanted inter-digital transducer 1121 on the piezoelectric layer 146 which is deposited on the structural layer 145. The length of the quasi-slanted finger inter-digital transducer 1121 is W12 which is approximately equal to the distance L between top row nozzles and lower row nozzles of the fluid injector 143, thereby preventing crosstalk. A passivation layer 148 is formed on the quasi-slanted inter-digital transducer 1121. A cover layer 149 is overlaid on the structural layer 145. Compared to the fluid injection device 140 of FIG. 22, the quasi-slanted finger inter-digital transducer 1121 also can generate a discrete SAW signal to analyze the injector surface and then trigger stronger SAW signals to decompose ink puddles or contaminants on the injector surface.

Since the quasi-slanted inter-digital transducer 1121 provides stronger discrete SAW, the surface of the injection device can be more efficiently cleaned.

The invention is advantageous in that a fluid injection device with a SAW device is provided to generate a broadband SAW signal to analyze and then a stronger SAW signal to remove the ink puddles or contaminated area from the surface of the injector device.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fluid injection device, comprising:
a fluid injector comprising:
a fluid chamber in a substrate to accommodate a fluid with a structural layer thereon;
at least one actuator disposed on the structural layer opposing the fluid chamber; and
a nozzle adjacent to the at least one actuator passing through the structural layer and connecting the fluid chamber; and
a surface acoustic wave (SAW) device using slanted finger inter-digital transducers (SFIT) disposed on the structural layer.

2. The fluid injection device as claimed in claim 1, wherein the fluid injector comprises a monolithic fluid injector.

3. The fluid injection device as claimed in claim 1, wherein the fluid injector comprises a thermal bubble driven fluid injector or a piezoelectric driven fluid injector.

4. The fluid injection device as claimed in claim 1, wherein the structural layer is a low stress silicon nitride (Si₃N₄).

5. The fluid injection device as claimed in claim 1, wherein the SAW device using slanted finger inter-digital transducers comprises at least one SFIT SAW device.

6. The fluid injection device as claimed in claim 1, wherein the SAW device using slanted finger inter-digital transducers comprises a SFIT SAW transmitter and a SFIT SAW receiver, wherein the nozzle is positioned adjacent to the SFIT SAW transmitter and the SFIT SAW receiver.

7. The fluid injection device as claimed in claim 1, wherein the SAW device using slanted finger inter-digital transducers comprises a piezoelectric layer on the structural layer, a plurality of slanted finger inter-digital electrodes disposed on the piezoelectric layer, and a passivation layer covering the piezoelectric layer and the slanted finger inter-digital electrodes.

8. The fluid injection device as claimed in claim 1, wherein the SAW device using slanted finger inter-digital transducers comprises a plurality of slanted finger inter-digital electrodes on the structural layer, a piezoelectric layer on the plurality of slanted finger inter-digital electrodes, and a passivation layer covering the piezoelectric layer and the slanted finger inter-digital electrodes.

9. The fluid injection device as claimed in claim 1, wherein the SAW device using slanted finger inter-digital transducers comprises a plurality of slanted finger inter-digital electrodes on the structural layer, and a piezoelectric layer on the plurality of slanted finger inter-digital electrodes.

10. The fluid injection device as claimed in claim 1, wherein the SAW device using slanted finger inter-digital transducers comprises at least one slanted finger inter-digital transducer.

11. A fluid injection device, comprising:
a fluid injector; and
a surface acoustic wave (SAW) device using slanted finger inter-digital transducers disposed on a structural layer of the fluid injector.

12. The fluid injection device as claimed in claim 11, wherein the fluid injector comprises a monolithic fluid injector.

13. The fluid injection device as claimed in claim 11, wherein the fluid injector comprises a thermal bubble driven fluid injector or a piezoelectric driven fluid injector.

14. The fluid injection device as claimed in claim 11, wherein the SAW device using slanted finger inter-digital transducers comprises at least one slanted finger inter-digital transducer.

15. The fluid injection device as claimed in claim 11, wherein the SAW device using slanted finger inter-digital transducers comprises a piezoelectric layer on the structural layer, a plurality of slanted finger inter-digital electrodes disposed on the piezoelectric layer, and a passivation layer covering the piezoelectric layer and the slanted finger inter-digital electrodes.

16. The fluid injection device as claimed in claim 11, wherein the SAW device using slanted finger inter-digital transducers comprises a plurality of slanted finger inter-digital electrodes on the structural layer, a piezoelectric layer on the plurality of slanted finger inter-digital electrodes, and a passivation layer covering the piezoelectric layer and the slanted finger inter-digital electrodes.

17. The fluid injection device as claimed in claim 1, wherein the SAW device using slanted finger inter-digital transducers comprises a plurality of slanted finger inter-digital electrodes on the structural layer, and a piezoelectric layer on the plurality of slanted finger inter-digital electrodes.

18. A fluid injection device, comprising:
a fluid injector; and
a SAW transmitter using slanted finger inter-digital transducers and a SAW receiver using slanted finger inter-digital transducers disposed on a structural layer of the fluid injector;
wherein a nozzle of the fluid injector is positioned adjacent to the SFIT SAW transmitter and the SFIT SAW receiver.

19. The fluid injection device as claimed in claim 18, wherein the fluid injector comprises a monolithic fluid injector.

20. The fluid injection device as claimed in claim 18, wherein the fluid injector comprises a thermal bubble driven fluid injector or a piezoelectric driven fluid injector.

21. The fluid injection device as claimed in claim 18, wherein the SAW device using slanted finger inter-digital transducers comprises at least one slanted finger inter-digital transducer.

22. The fluid injection device as claimed in claim 18, wherein the SAW device using slanted finger inter-digital transducers comprises a piezoelectric layer on the structural layer, a plurality of slanted finger inter-digital electrodes disposed on the piezoelectric layer, and a passivation layer covering the piezoelectric layer and the slanted finger inter-digital electrodes.

23. The fluid injection device as claimed in claim 18, wherein the SAW device using slanted finger inter-digital transducers comprises a plurality of slanted finger inter-digital electrodes on the structural layer, a piezoelectric layer on the plurality of slanted finger inter-digital electrodes, and a passivation layer covering the piezoelectric layer and the slanted finger inter-digital electrodes.

24. The fluid injection device as claimed in claim 18, wherein the SAW device using slanted finger inter-digital transducers comprises a plurality of slanted finger inter-digital electrodes on the structural layer, and a piezoelectric layer on the plurality of slanted finger inter-digital electrodes.

25. A method of analyzing a fluid injection device, comprising:
providing the fluid injection device with a SAW transmitter using slanted finger inter-digital transducers and a SAW receiver using slanted finger inter-digital transducers, wherein a nozzle of the fluid injector is positioned adjacent to the SFIT SAW transmitter and the SFIT SAW receiver;
a broadband SAW spectrum generated by the SFIT SAW transmitter passing through the nozzle and received by the slanted finger inter-digital SAW receiver; and
comparing the SAW spectrum received by the SFIT SAW receiver with a SAW spectrum without surface contamination,
wherein if the SAW spectrum received by the SFIT SAW receiver is equal to the SAW spectrum without surface contamination, then continuing printing procedure; and if the SAW spectrum received by the SFIT SAW receiver is less than the SAW spectrum without surface contamination due to a contaminated area, then proceeding with a maintenance procedure.

26. The method as claimed in claim 25, wherein the contaminated area comprises an ink puddle residue on the surface of the fluid injection device.

27. The method as claimed in claim 25, wherein fluid injection device comprises:
a fluid chamber in a substrate to accommodate a fluid with a structural layer thereon;
at least one actuator disposed on the structural layer opposing the fluid chamber; and
a nozzle adjacent to the at least one actuator passing through the structural layer and connecting the fluid chamber.

28. The method as claimed in claim 25, wherein the fluid injection device comprises a thermal bubble driven fluid injector or a piezoelectric driven fluid injector.

29. The method as claimed in claim 25, wherein the SAW device using slanted finger inter-digital transducers comprises at least one slanted finger inter-digital transducer.

30. A method of maintaining a fluid injection device, comprising:
providing the fluid injection device with a SAW device using slanted finger inter-digital transducers on a fluid injector; and
a broadband SAW spectrum generated by the SFIT SAW transmitter passing through a contaminated area to decompose the contamination by SAW vibration.

31. The method as claimed in claim 30, wherein the contaminated area comprises an ink puddle residue on the surface of the fluid injection device.

32. The method as claimed in claim 30, wherein the SAW device using slanted finger inter-digital transducers comprises a SFIT SAW transmitter and a SFIT SAW receiver, wherein the SFIT SAW device detects the location of the contaminated area and generates stronger SAW signal to decompose the contamination as well as to clean the surface of the injector.
